(19) United States
(12) Patent Application Publication
(10) Pub. No.: US 2026/0105571 A1
(43) Pub. Date: Apr. 16, 2026

(54) METHOD FOR DETECTING AN OFFSET BETWEEN AN OUTLINE OF A POLYGONAL OBJECT PRODUCED AND A DESIGNED OUTLINE UNDER A DESIGN FOR THE POLYGONAL OBJECT

(71) Applicant: Centrum Technology Corporation, Taoyuan (TW)

(72) Inventors: Wen-Chung CHUANG, Taoyuan (TW); Hao-Wei HSU, Taoyuan (TW)

(21) Appl. No.: 19/297,246

(22) Filed: Aug. 12, 2025

(30) Foreign Application Priority Data
Oct. 14, 2024 (TW) 113139050

(51) Int. Cl. G06T 3/60; G06T 7/13; G06V 10/44

(52) U.S. Cl. CPC G06T 3/60; G06T 7/13; G06V 10/44; G06T 2207/30141; G06T 2207/30152

(57) ABSTRACT

A method of adjusting an orientation of an outline image of a polygonal object obtained by detecting a first outline of the polygonal object is disclosed. The method includes the following steps: (a) determining a plurality of feature points from the first outline of the polygonal object; (b) identifying a plurality of positional parameters for the plurality of feature points; (c) obtaining a virtual outline of the polygonal object by associating the plurality of positional parameters; (d) determining a center of rotation based on the virtual outline; and (e) rotating the virtual outline along the center of rotation to the orientation to generate an orientation-aligned outline.

### CROSS-REFERENCE TO RELATED APPLICATION AND CLAIM OF PRIORITY

This application claims the benefit of the Taiwan Patent Application No. 113139050, filed on October 14, 2024 at the Taiwan Intellectual Property Office, the disclosures of which are incorporated herein in their entirety by reference.

### FIELD OF THE INVENTION

The present invention is related to a method for inspecting a product by detecting real-time images of the product. Particularly, the present invention is related to a method for adjusting an orientation of a designed outline under a design for a polygonal object by detecting an offset between an outline of a produced polygonal object based on real-time images of the produced polygonal object and a designed outline under a design for the polygonal object.

### BACKGROUND OF THE INVENTION

When IC carrier boards or circuit boards are manufactured in a mass production scale, they are usually manufactured on a big mother substrate for mass production. Each of the IC carrier boards or circuit boards may have a polygonal shape. For example, each of the circuit boards can directly or indirectly carry various electronic components, such as ICs and the carrier boards therefor, and the resistors, capacitors, semiconductors, LEDs, etc. An IC carrier board is a key component in the packaging process that functions as a carrier to carry ICs, protect and secure the circuits disposed thereon, and dissipate heat generated from ICs and the circuits. Accordingly, the precision requirements for making an IC carrier board are extremely strict. Meanwhile, if an object, such as an IC carrier board, having a polygonal shape needs to be processed and further assembled into a space inside an equipment, a device, a structure, or a housing, the limited volume in this space should be sufficiently utilized by compacting the object. The tolerance for assembling the object in the space will not be large. On the contrary, if the tolerance for assembling the object is enlarged, the space left for the other electronic components should be decreased, and thus it is impossible to accommodate more electronic components in the limited space. For determining whether an outline of the object having a polygonal shape is different from a designed outline for the object, in the prior art, taking an IC carrier board as the object, for example, an image sensor, such as a signal charged couple device (CCD), is used to detect the outline of the IC carrier board. By moving the image sensor around four sides of the object/IC carrier, the features including the edges and corners of the object, or those of a boundary of a circuit area and the non-circuit area (or called the non-effective area) on the object, can be detected optically. Accordingly, by comparing the data obtained from the edges and corners and the corresponding data of the designed outline, the offset/deviation between the outline of the object and the designed outline are obtained. When plural objects are to be detected, such as the circuit boards or IC carrier boards, they are placed on a tray in rows and columns; however, most of them are not always neatly arranged on the tray, which means that each edge of each object is not oriented or aligned to a desired orientation (or called a reference orientation or a designed orientation) preset for translational offset/rotational offset detection, so each object having a translational offset and/or rotational offset in the tray is required to be compared with the designed outline of the object. Therefore it is extremely important that, before comparing the data obtained from the detected object and data of the designed outline, it is necessary to orientate the images (to be converted into the detected data such as the lengths of the edges and the coordinates of the corners) of the object detected by the optical sensor in alignment with the orientation of the designed outline, so that the comparison can be done and then the outline of the object is determined to be within the production tolerance or not. In addition, by using the prior techniques, the image of the entire object to be detected can be obtained by taking the image through a single camera device, and then capturing the outline and corners from the image. However, for a panoramic view of the object to be captured, the proportion of each corner of the object in the image is very small. Taking the circuit board or IC carrier board as an example, the object normally has a rectangular surface, and practically the images of four corners of the object are detected, and their positional values or the coordinates are calculated and obtained by sequentially connecting virtual lines between all adjacent corners, and then the detected outline of the entire object can be obtained. Thus, this can be achieved by moving a single camera relative to a tray that carries at least one object to be detected, such that the single camera can be aimed at each top side of a corner of the at least one object in a different direction. However, this technology may generate movement errors when a moving device moves the tray and at least one object carried thereon, resulting in an error to each image of the object captured by the optical lens of the camera. This error will further cause an error of the value measured. Therefore, how to reduce the numbers of camera movements to improve the accuracy of measurement, and after obtaining the data for each corner of the object, properly adjust and align the acquired image so as to better compare it with the designed outline of the object is a problem that needs to be solved urgently.

### SUMMARY OF THE INVENTION

First of all, for comparing the outline of an object with the designed outline with ease, the present invention provides the method by taking the image(s) of the object; retrieving the data of each corners of the object from the image(s); connecting virtual lines between two adjacent corners to form an virtual outline of the object, and adjusting the orientation of the virtual outline of the object to be in a predetermined orientation that aligns with the orientation of the designed outline. Second, for avoiding the errors caused by plural movements of the single camera moving above/around the corners of the object, or for avoiding the insufficient resolutions of the object caused by the panoramic image taken by the single camera at all corners of the object, it is possible to use multiple cameras, wherein the numbers of the cameras usually correspond to the numbers of the corners of the object, disposed above each corner to take images of the object, so that the errors caused by the movement of the single camera are eliminated, or the resolutions of the images taken on all of the corners are increased. Therefore, the accuracy to compare the virtual outline of the object with the designed outline is improved.

In accordance with one aspect of the present disclosure, a method for detecting an offset between an outline of a polygonal object produced and a designed outline under a design for the polygonal object is disclosed. The polygonal object has thereon a non-effective area and a circuit area surrounded by the non-effective area, and the circuit area has plural internal corners and plural solder joints. The method includes the following steps: capturing an outline image for the outline of the polygonal object to obtain a virtual outline; capturing ones of (1) plural internal corner images for the plural internal corners, and (2) plural solder joint images for the plural solder joints closest to the plural internal corners wherein the plural solder points are included in the circuit area; determining plural feature points based on ones of (1) the plural internal corner images and (2) the plural solder joint images; forming a first virtual line connecting two feature points non-adjacent to each other from the plural feature points on the virtual outline; forming a second virtual line connecting another two feature points from the plural feature points; determining an intersection point based on the first virtual line and the second virtual line; taking the intersection point as a center of rotation; rotating the virtual outline along the center of rotation to a specific orientation, in which the virtual outline is supposed to be aligned with the designed outline, to generate an orientation-aligned outline; and comparing the orientation-aligned outline with the designed outline to obtain the offset.

In accordance with another aspect of the present disclosure, a method for detecting an offset of an outline of a polygonal object produced from a designed outline therefor is disclosed. The method includes the following steps: determining at least four feature points from the outline of the polygonal object; obtaining a virtual polygonal outline by connecting the at least four feature points in one of a clockwise direction and a counterclockwise direction; forming a first virtual line connecting two of the plural feature points non-adjacent to each other on the virtual polygonal outline; forming a second virtual line connecting another two of the feature points; taking an intersection point of the first virtual line and the second virtual line as a center of rotation; rotating the virtual outline along the center of rotation to a specific orientation to generate an orientation-aligned outline corresponding to the designed outline; and comparing the orientation-aligned outline with the designed outline to obtain the offset.

In accordance with a further aspect of the present disclosure, a method of adjusting an orientation of an outline image of a polygonal object obtained by detecting a first outline of the polygonal object is disclosed. The method includes the following steps: (a) determining a plurality of feature points from the first outline of the polygonal object; (b) identifying a plurality of positional parameters for the plurality of feature points; (c) obtaining a virtual outline of the polygonal object by associating the plurality of positional parameters; (d) determining a center of rotation based on the virtual outline; and (e) rotating the virtual outline along the center of rotation to the orientation to generate an orientation-aligned outline.

The above objectives and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a schematic diagram showing the marks or portions on a top side of the polygonal object to be measured according to an embodiment of the present invention;

FIG. 2 is a schematic diagram showing the marks or portions on a back side of the polygonal object to be measured according to an embodiment of the present invention;

FIG. 3 is a schematic diagram showing plural polygonal objects disposed on a tray according to an embodiment of the present invention;

FIG. 4 is a schematic drawing showing a device having multiple cameras according to an embodiment of the present invention;

FIGS. 5A to 5D are schematic diagrams each showing the corner portion viewed from the top side of a polygonal object to be detected according to an embodiment of the present invention;

FIGS. 6A to 6D are schematic diagrams each showing the corner portion viewed from the back side of a polygonal object to be detected according to an embodiment of the present invention;

FIG. 7 is a schematic diagram showing a state in which the virtual outline of the polygonal object to be detected is about to be aligned with the designed outline of the polygonal object according to the present invention;

FIG. 8 is a schematic diagram showing a comparison result between the virtual outline and the designed outline of the polygonal object according to the present invention;

FIG. 9 is a schematic diagram showing a comparison result between the top side and the back side of the virtual outline of the polygonal object according to another embodiment of the present invention;

FIG. 10 is a schematic diagram showing a front view of FIG. 9; and

FIG. 11 is a schematic diagram showing one corner portion at the top side of the virtual outline of the polygonal object and the solder joints on the back side of the same corner portion according to the present invention.

### DETAILED DESCRIPTION OF THE PREFERRED EMBODIMENTS

Please refer to all drawings of the present invention when reading the following detailed descriptions, wherein all drawings of the present invention demonstrate different embodiments of the present invention by showing examples, and help the skilled person in the art to understand how to implement the present invention. The present examples provide sufficient embodiments to demonstrate the spirit of the present invention. Each embodiment does not conflict with the others, and new embodiments can be implemented through an arbitrary combination thereof. Therefore, the present invention is not restricted to the embodiments disclosed in the present specification.

Unless there are other restrictions defined in the specific example, the following definitions apply to the terms used throughout the specification.

The present invention can be used for detecting a polygonal object, such as a substrate (e.g., an IC carrier board) and a PCB, that is required to be precisely measured to ensure that it is a good product before shipment. The measured data can be further analyzed, and based on the variations of the data, it can be determined what should be paid attention to in the previous process, such as the degree of wear of the tool used to cut the product or the setting of the precision required for cutting. For more accurate comparison and correction, the present invention uses a single-camera or multiple-camera device to take photographs and capture the respective outline image for each of the various feature points (such as each of the plural internal corner images for the internal corners) of the object to be measured, and the data obtained from those photographs, i.e., the captured outline images of the plural feature points, further form a virtual outline (namely, the polygonal result of the polygonal relationship) of the object to be measured, and then the virtual outline of the object is rotated to align with the designed outline under a design for the polygonal object and compare with it. The number of the plural feature points can be at least three, and the feature points can be selected from the same number of the ones of the plural internal corners of the polygonal object. Alternatively, on a condition that the plural feature points are not selected from the plural internal corners, the solder joints of the same number predetermined from the plural solder joints disposed on the object can be selected as the feature points. The solder joint images taken from the respective solder joints are processed by the image processing unit accordingly. The present invention further provide a multiple-camera device serving as an image sensing unit, in which the plural camera devices are used to detect the respective corner of the polygonal object, and the camera devices disposed at predetermined positions capture/detect the corner images of the corners sequentially or simultaneously, so that the error resulting from the movement of the hardware (i.e., in the case of the single camera) no longer exists. By capturing the images (of the corners) of the object to be detected at one time, the efficiency of taking images is improved, and when moving the camera device to detect the next object, the movement will not cause a change in the distance between any two of the plural camera devices, thereby improving the stability of the detection accuracy.

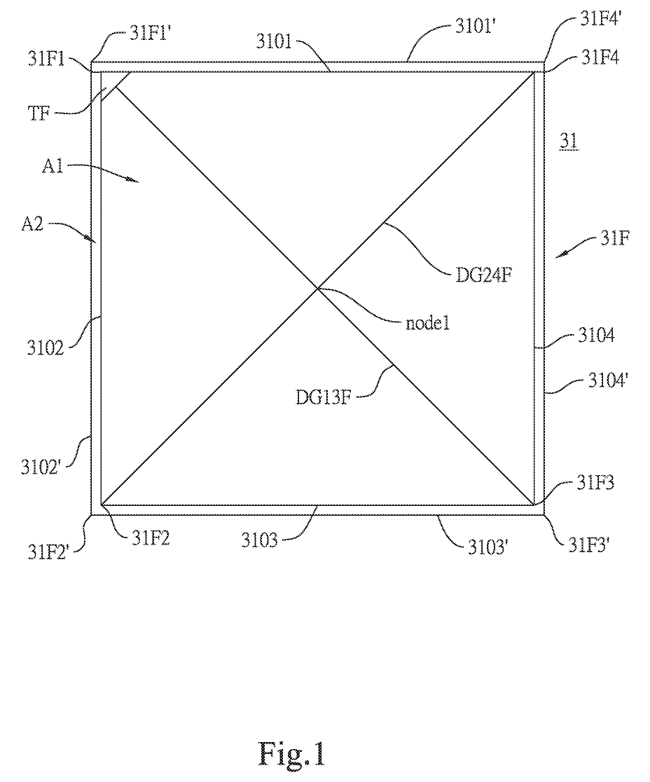

FIG. 1 is a schematic diagram showing the marks or portions on a top side of the polygonal object to be measured according to an embodiment of the present invention. Please refer to FIG. 1, an IC carrier board as an example serves as the polygonal object to be detected by an image processing unit that is coupled to the camera devices and obtains the image therefrom. It can be seen that, when viewing from top side (or called the top surface) 31F of the carrier board 31, it is usually quadrilateral (or called quadrangle), and the top side 31F represents the above-mentioned polygonal result of polygonal relationship. At the top side 31F of the carrier board 31, the circuit area A1 has four corners, including the first internal corner 31F1, the second internal corner 31F2, the third internal corner 31F3, and the fourth internal corner 31F4. Similarly, the first external corner 31F1', the second external corner 31F2', the third external corner 31F3', and the fourth external corner 31F4' at the top side 31F can also be seen in the non-circuit area A2 that surrounds the circuit area A1. The internal corner images for the respective internal corners are captured by the camera devices, and are determined as the plural feature points on the polygonal object. A first internal edge line 3101 can be virtually drawn to connect two adjacent internal corners (i.e., the internal corner portions), such as the internal corners 31F1 and 31F4, and another three virtual lines, including a second internal edge line 3102, a third internal edge line 3103, and a fourth internal edge line 3104, can be virtually drawn sequentially to connect the internal corners 31F2, 31F3 and 31F4 by the image processing unit. Similarly, the other four virtual lines, including a first external edge line 3101', a second external edge line 3102', a third external edge line 3103', and a fourth external edge line 3104', can be virtually drawn through the four external corners (i.e. the external corner portions) 31F1’, 31F2’, 31F3’ and 31F4’ by the image processing unit. Furthermore, a first top diagonal line DG13F as a first virtual line is virtually drawn by the image processing unit to connect the first internal corner 31F1 and the third internal corner 31F3; and a second top diagonal line DG24Fas a second virtual line is virtually drawn to connect the second internal corner 31F2 and the fourth internal corner 31F4. The two diagonal lines DG13Fand DG24F intercept and generate an intersection point node1 by the image processing unit. In addition, for the convenience of orientation correction, a top triangle mark TF is usually created near/on a corner at the top side 31F of the carrier board 31. In FIG. 1, the mark TF is located at the upper left side of the top side 31F, e.g., located adjacent to or closest to the first internal corner 31F1, but it is not limited thereto. Generally speaking, the present invention uses the intersection point node1 as the reference point for comparing the virtual outline with the designed outline under a design for the object, to overlap the intersection point node1 with the intersection point of the two corresponding diagonals on the designed outline, and then the top side 31F of the virtual outline is rotated to be in the same orientation as, or is aligned with, the designed outline for comparison by the image processing unit to generate an orientation-aligned outline. The orientation-aligned outline aligned with the designed outline can be done by selecting one of the lateral edges of the designed outline of the object as the base side (or a base edge), and the matching corresponding side of the virtual outline with the base side of the designed outline. The base side of the orientation-aligned outline is parallel to the corresponding base side of the designed outline, and is compared by the image sensing unit.

In an alternative embodiment according to the present invention, the polygonal object further includes a pair of alignment marks disposed thereon, and the step of rotating the virtual outline of the polygonal object to the specific orientation is based on a detection of two mark positions of the pair of alignment marks

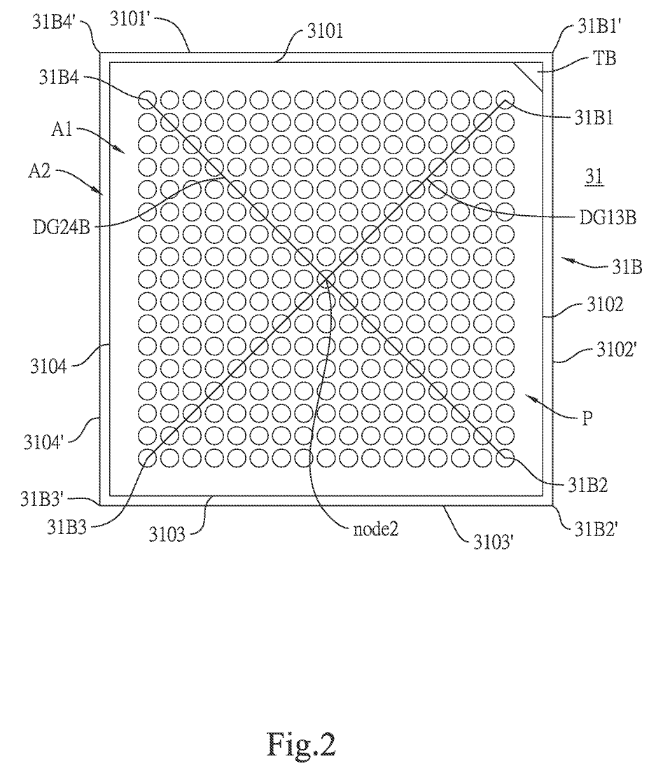

FIG. 2 is a schematic diagram showing the marks or portions on a back side of the polygonal object to be measured according to an embodiment of the present invention. Please refer to FIG. 2, an IC carrier board serves as the polygonal object to be detected, for example. It can be seen that, when viewing from back side (or called the back surface) 31B of the carrier board 31, it is usually quadrilateral (or called quadrangle), and the back side 31B represents a backside polygonal result of polygonal relationship. At the back side 31B of the carrier board 31, the circuit area A1 has plural corner solder joints P and four external corners (or called external corner portions) 31B1’, 31B2’, 31B3’ and 31B4’, and either the images of plural corner solder points P or the four external corners 31B1’, 31B2’, 31B3’ and 31B4’ can be determined as the plural feature points for the back side polygonal result. The plural corner solder joints P includes the first corner solder joint 31B1, the second corner solder joint 31B2, the third corner solder joint 31B3, and the fourth corner solder joint 31B4. Similarly, the first external corner 31B1', the second external corner 31B2', the third external corner 31B3' and the fourth external corner 31B4' at the back side 31B can be seen in the non-circuit area A2. By directly capturing with the camera devices, a first internal edge line 3101, a second internal edge line 3102, a third internal edge line 3103 and a fourth internal edge line 3104 can be obtained. Similarly, each of the external corners (or called external corner portions) can be virtually drawn to form a first external edge line 3101', a second external edge line 3102', a third external edge line 3103' and a fourth external edge line 3104'. Furthermore, the first corner solder joint 31B1 and the third corner solder joint 31B3 are virtually connected to form a first back diagonal line DG13B; and the second corner solder joint 31B2 and the fourth corner solder joint 31B4 are virtually connected to form a second back diagonal line DG24B. The two diagonals DG13B and DG24B intercept and generate an opposite intersection point node2. In addition, for the convenience of orientation alignment/correction, a back triangle mark TB is usually created at a corner of the back side 31B of the carrier board 31. In FIG. 2, the mark TB is located at the upper right corner at the back side 31B (correspondgint to the upper left side of the first top side 31F) of the carrier board 31, e.g., located adjacent to or closest to the first corner solder joint 31B1, but it is not limited thereto. However, the back triangle mark TB is usually mirror-symmetrical to the top triangle mark TF. Generally speaking, the present invention uses the opposite intersection point node2 as the reference point for comparing the virtual outline with the designed outline of the object, to overlap the opposite intersection point node2 with the intersection point of the two corresponding diagonals on the designed outline, and then the back side 31B of the virtual outline is rotated to be in the same orientation as, or is aligned with, the designed outline for comparison. Please note that because the top side 31F and the back side 31B are mutually in a mirror image relationship, the back side 31B shown in FIG. 2 is actually the polygonal result of flipping the carrier board 31 left to right, and the points and edges on the back side 31B is sequentially named corresponding to the mirror image of the top side 31F.

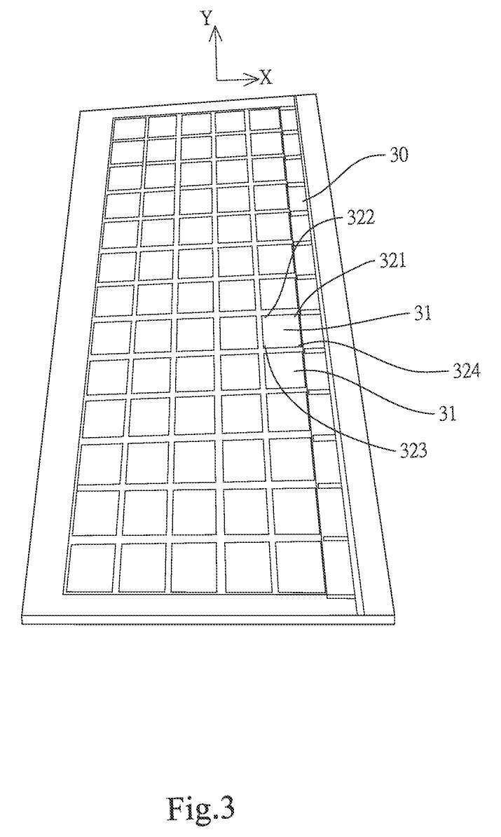

FIG. 3 is a schematic diagram showing plural polygonal objects disposed on a tray according to an embodiment of the present invention. Please refer to FIG. 3, plural polygonal objects to be detected, e.g., carrier boards 31, are arranged on a tray 30. The carrier boards 31 are taken as an example for explanation here. Each of the carrier boards 31 has a first corner 321, a second corner 322, a third corner 323, and a fourth corner 324 corresponding to the tray 30. In order to capture the images of the above-mentioned corners, the present invention provides plural camera devices each disposed correspondingly to each corner of the respective carrier board 31 to capture each image of the corners. The descriptions related thereto will be further explained with FIG. 4 below. The X and Y directions shown in FIG. 3 are consistent with the corresponding directions shown in FIG. 4.

FIG. 4 is a schematic drawing showing a device having multiple cameras according to an embodiment of the present invention. Please refer to FIG. 4, an optical detection module 10 saving as image a sensing unit has a first camera device 11 located at a first position 21, a second camera device 12 located at a second position 22, a third camera device 13 located at a third position 23, and a fourth camera device 14 located at a fourth position 24. The X and Y directions of the tray 30 shown in FIG. 3 correspond to those of the optical detecting module 10 shown in FIG. 4, and thus the first corner 321, the second corner 322, the third corner 323, and the fourth corner 324 of the carrier board 31 shown in FIG. 3 correspond to the respective first position 21, the second position 22, the third position 23, and the fourth position 24 of the optical detection module 10. When the optical detection module 10 is moved onto a carrier board 31, the respective camera device on the optical detection module 10 will face at each position and capture an image of each of the corners 321 to 324 of a carrier board 31 on the tray 30, thereby obtaining the respective image of the corner portion shown in FIG. 1 and FIG. 2.

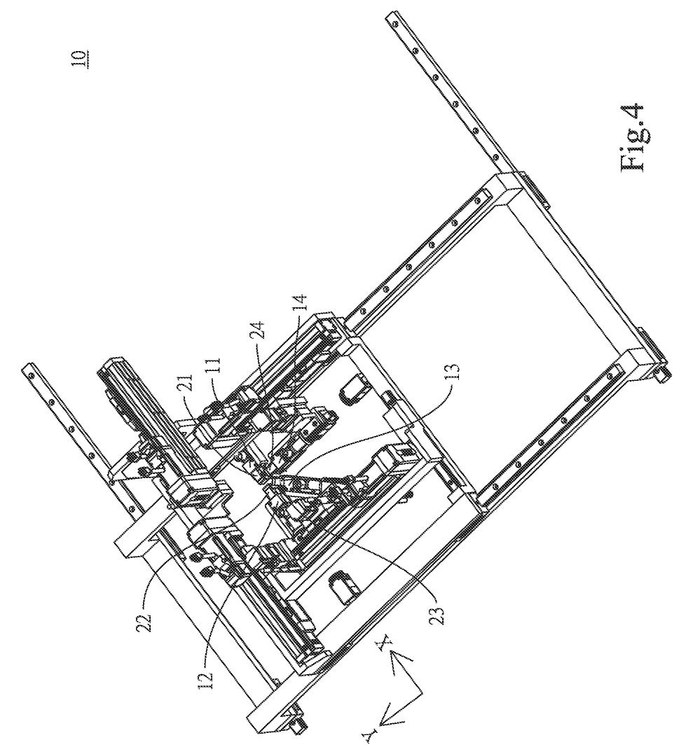

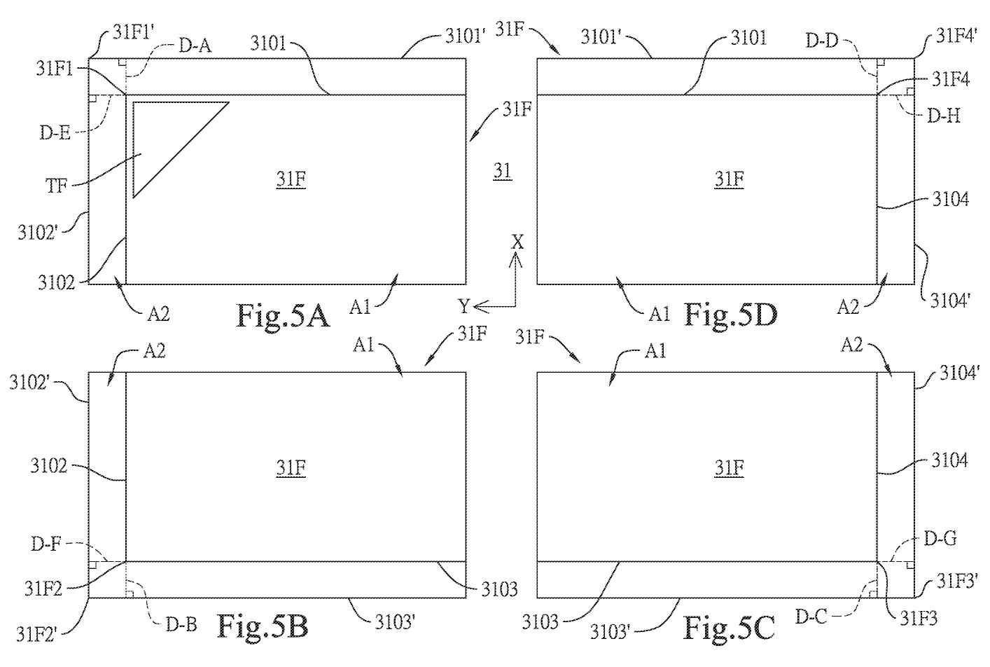

FIGS. 5A to 5D are schematic diagrams each showing the corner portion viewed from the top side of a polygonal object to be detected according to an embodiment of the present invention. The arrangement sequence of FIGS. 5A to 5D conforms to the sequence of the first position 21, the second position 22, the third position 23, and the fourth position 24 as shown in FIG. 4. That is, the X and Y directions shown in FIGS. 5A to 5D are also the same as those shown in FIG. 4. Please refer to FIG. 5A showing an image captured by the first camera device 11 when the corner portion at the top side 31F of the carrier board 31 is located at the first position 21 shown in FIG. 4. The captured image includes the first internal edge line 3101, the second internal edge line 3102, the first external edge line 3101', and the second external edge line 3102', as the aforementioned. The captured image further includes a top triangle mark TF, a first internal corner 31F1 and a first external corner 31F1'. Furthermore, an internal-external distance D-A (at position A) can be obtained from the distance between the first internal edge line 3101 and the first external edge line 3101'. Similarly, an internal-external distance D-E (at position E) can be obtained from the distance between the second internal edge line 3102 and the second external edge line 3102'. These two internal-external distances D-A and D-E are very important data, which determine whether the position of the first internal corner 31F1 at a corner of the circuit area A1 (i.e., the effective area) relative to the position of the first external corner 31F1’ at a corner of the non-circuit area A2 (i.e., the non-effective area) is within the tolerance allowed in the designed outline of the object to be detected.

FIGS. 5A to 5D are schematic diagrams each showing the corner portion viewed from the top side of a polygonal object to be detected according to an embodiment of the present invention. Please refer to FIG. 5B showing an image captured by the second camera device 12 when the corner portion at the top side 31F of the carrier board 31 is located at the second position 22 shown in FIG. 4. The captured image includes the third internal edge line 3103, the second internal edge line 3102, the third external edge line 3103', and the second external edge line 3102', as the aforementioned. The captured image further includes a second internal corner 31F2 and a second external corner 31F2'. Furthermore, an internal-external distance D-B (at position B) can be obtained from the distance between the third internal edge line 3103 and the third external edge line 3103'. Similarly, an internal-external distance D-F (at position F) can be obtained from the distance between the second internal edge line 3102 and the second external edge line 3102'. These two internal-external distances D-B and D-F are very important data, which determine whether the position of the second internal corner 31F2 at a corner of the circuit area A1 (i.e., the effective area) relative to the position of the second external corner 31F2’ at a corner of the non-circuit area A2 (i.e., the non-effective area) is within the tolerance allowed in the designed outline of the object to be detected.

FIGS. 5A to 5D are schematic diagrams each showing the corner portion viewed from the top side of a polygonal object to be detected according to an embodiment of the present invention. Please refer to FIG. 5C showing an image captured by the third camera device 13 when the corner portion at the top side 31F of the carrier board 31 is located at the third position 23 shown in FIG. 4. The captured image includes the third internal edge line 3103, the fourth internal edge line 3104, the third external edge line 3103', and the fourth external edge line 3102', as the aforementioned. The captured image further includes a third internal corner 31F3 and a third external corner 31F3'. Furthermore, an internal-external distance D-C (at position C) can be obtained from the distance between the third internal edge line 3103 and the third external edge line 3103'. Similarly, an internal-external distance D-G (at position G) can be obtained from the distance between the fourth internal edge line 3104 and the fourth external edge line 3104'. These two internal-external distances D-C and D-G are very important data, which determine whether the position of the second internal corner 31F3 at a corner of the circuit area A1 (i.e., the effective area) relative to the position of the second external corner 31F3’ at a corner of the non-circuit area A2 (i.e., the non-effective area) is within the tolerance allowed in the designed outline of the object to be detected.

FIGS. 5A to 5D are schematic diagrams each showing the corner portion viewed from the top side of a polygonal object to be detected according to an embodiment of the present invention. Please refer to Fig. D showing an image captured by the first camera device 14 when the corner portion at the top side 31F of the carrier board 31 is located at the fourth position 24 shown in FIG. 4. The captured image includes the first internal edge line 3101, the fourth internal edge line 3104, the first external edge line 3101', and the fourth external edge line 3104', as the aforementioned. The captured image further includes a fourth internal corner 31F4 and a fourth external corner 31F4'. Furthermore, an internal-external distance D-D (at position D) can be obtained from the distance between the first internal edge line 3101 and the first external edge line 3101'. Similarly, an internal-external distance D-H (at position H) can be obtained from the distance between the fourth internal edge line 3104 and the fourth external edge line 3104'. These two internal-external distances D-D and D-H are very important data, which determine whether the position of the second internal corner 31F4 at a corner of the circuit area A1 (i.e., the effective area) relative to the position of the second external corner 31F4’ at a corner of the non-circuit area A2 (i.e., the non-effective area) is within the tolerance allowed in the designed outline of the object to be detected. Taking the internal-external distance D-A at position A in FIG. 5A as an example, the internal-external distances D-A at position A is the actual vertical distance between the position close to the first internal corner 31F1 at the first internal edge line 3101 and the position at the first external edge line 3101'. The other internal-external distances at positions B to H are all defined by the same concept.

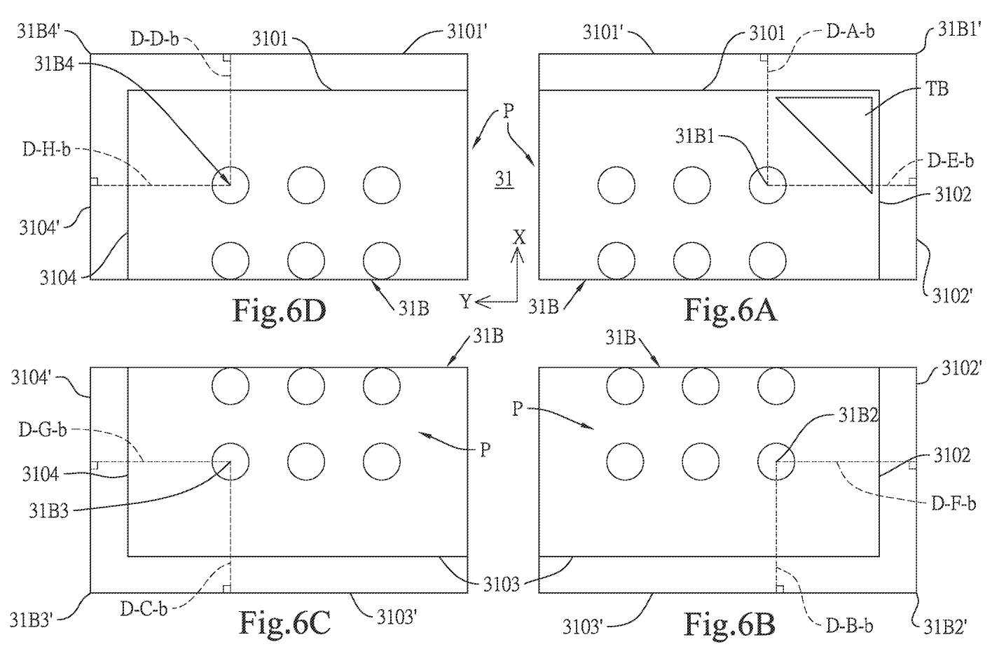

FIGS. 6A to 6D are schematic diagrams each showing the corner portion viewed from the back side of a polygonal object to be detected according to an embodiment of the present invention. Because the image of FIGS. 6A to 6D are taken from back side of the tray 30, FIGS. 6A to 6D each shows a corner portion by turning the tray 30 left to right. Therefore, the sequence of FIGS. 6A to 6D corresponds to a sequence with flipping the tray 30 left to right as shown in FIGS. 5A to 5D, and several solder joints Ps located at back side of the object can be seen accordingly. Please refer to FIG. 6A showing an image captured by the fourth camera device 14 when the corner portion at the back side 31B of the carrier board 31 (as shown in FIG. 2) is located at the fourth position 24 shown in FIG. 4. The captured image includes the first internal edge line 3101, the second internal edge line 3102, the first external edge line 3101' and the second external edge line 3102' as the aforementioned. The captured image further includes a bottom triangle mark TB, a first internal corner solder joint 31B1 and a first external corner solder joint 31B1'. Furthermore, an internal-external distance D-A-b (at position A of the bottom of the object) can be obtained from the distance between the first internal corner solder joint 31B1 (say, the center thereof) and the first external edge line 3101'. Similarly, an internal-external distance D-E-b (at position E of the bottom of the object) can be obtained from the distance between the first internal corner solder joint 31B1 (say, the center thereof) and the second external edge line 3102'. These two internal-external distances D-A-b and D-E-b are very important data, which determine whether the positional deviation or inclination in a vertical direction between the top side 31F and the back side 31B (or that of the lateral edge) of the corner portion of the carrier board 31, which is caused by processing error, is within the tolerance allowed in the designed outline of the object to be detected. The positional deviation can be obtained by calculating the offsets between the two internal-external distances of D-A and D-A-b and between the two internal-external distances of D-E and D-E-b.

FIGS. 6A to 6D are schematic diagrams each showing the corner portion viewed from the back side of a polygonal object to be detected according to an embodiment of the present invention. Because the image of FIGS. 6A to 6D are taken from back side of the tray 30, FIGS. 6A to 6D each shows a corner portion by turning the tray 30 left to right. Therefore, the sequence of FIGS. 6A to 6D corresponds to a sequence with flipping the tray 30 left to right as shown in FIGS. 5A to 5D, and several solder joints Ps located at back side of the object can be seen accordingly. Please refer to FIG. 6B showing an image captured by the third camera device 13 when the corner portion at the back side 31B of the carrier board 31 (as shown in FIG. 2) is located at the third position 23 shown in FIG. 4. The captured image includes the third internal edge line 3103, the second internal edge line 3102, the third external edge line 3103' and the second external edge line 3102' as the aforementioned. The captured image further includes a second internal corner solder joint 31B2 and a second external corner solder joint 31B2'. Furthermore, an internal-external distance D-B-b (at position B of the bottom of the object) can be obtained from the distance between the first internal corner solder joint 31B2 (say, the center thereof) and the third external edge line 3103'. Similarly, an internal-external distance D-F-b (at position F of the bottom of the object) can be obtained from the distance between the second internal corner solder joint 31B2 (say, the center thereof) and the second external edge line 3102'. These two internal-external distances D-B-b and D-F-b are very important data, which determine whether the positional deviation or inclination in a vertical direction between the top side 31F and the back side 31B (or that of the lateral edge) of the corner portion of the carrier board 31, which is caused by processing error, is within the tolerance allowed in the designed outline of the object to be detected. The positional deviation can be obtained by calculating the offsets between the two internal-external distances of D-B and D-B-b and between the two internal-external distances of D-F and D-F-b.

FIGS. 6A to 6D are schematic diagrams each showing the corner portion viewed from the back side of a polygonal object to be detected according to an embodiment of the present invention. Because the image of FIGS. 6A to 6D are taken from back side of the tray 30, FIGS. 6A to 6D each shows a corner portion by turning the tray 30 left to right. Therefore, the sequence of FIGS. 6A to 6D corresponds to a sequence with flipping the tray 30 left to right as shown in FIGS. 5A to 5D, and several solder joints Ps located at back side of the object can be seen accordingly. Please refer to FIG. 6C showing an image captured by the second camera device 12 when the corner portion at the back side 31B of the carrier board 31 (as shown in FIG. 2) is located at the second position 22 shown in FIG. 4. The captured image includes the third internal edge line 3103, the fourth internal edge line 3104, the third external edge line 3103' and the fourth external edge line 3104' as the aforementioned. The captured image further includes a third internal corner solder joint 31B3 and a third external corner solder joint 31B3'. Furthermore, an internal-external distance D-C-b (at position C of the bottom of the object) can be obtained from the distance between the third internal corner solder joint 31B3 (say, the center thereof) and the third external edge line 3103'. Similarly, an internal-external distance D-G-b (at position F of the bottom of the object) can be obtained from the distance between the third internal corner solder joint 31B3 (say, the center thereof) and the fourth external edge line 3104'. These two internal-external distances D-C-b and D-G-b are very important data, which determine whether the positional deviation or inclination in a vertical direction between the top side 31F and the back side 31B (or that of the lateral edge) of the corner portion of the carrier board 31, which is caused by processing error, is within the tolerance allowed in the designed outline of the object to be detected. The positional deviation can be obtained by calculating the offsets between the two internal-external distances of D-C and D-C-b and between the two internal-external distances of D-G and D-G-b.

FIGS. 6A to 6D are schematic diagrams each showing the corner portion viewed from the back side of a polygonal object to be detected according to an embodiment of the present invention. Because the images of FIGS. 6A to 6D are taken from back side of the tray 30, FIGS. 6A to 6D each show a corner portion by turning the tray 30 left to right. Therefore, the sequence of FIGS. 6A to 6D corresponds to a sequence with flipping the tray 30 left to right as shown in FIGS. 5A to 5D, and several solder joints Ps located at back side of the object can be seen accordingly. Please refer to FIG. 6D showing an image captured by the first camera device 11 when the corner portion at the back side 31B of the carrier board 31 (as shown in FIG. 2) is located at the first position 21 shown in FIG. 4. The captured image includes the first internal edge line 3101, the fourth internal edge line 3104, the first external edge line 3101' and the fourth external edge line 3104' as the aforementioned. The captured image further includes a fourth internal corner solder joint 31B4 and a fourth external corner solder joint 31B4'. Furthermore, an internal-external distance D-D-b (at position D of the bottom of the object) can be obtained from the distance between the fourth internal corner solder joint 31B4 (say, the center thereof) and the first external edge line 3101'. Similarly, an internal-external distance D-H-b (at position H of the bottom of the object) can be obtained from the distance between the fourth internal corner solder joint 31B4 (say, the center thereof) and the fourth external edge line 3104'. These two internal-external distances D-D-b and D-H-b are very important data, which determine whether the positional deviation or inclination in a vertical direction between the top side 31F and the back side 31B (or that of the lateral edge) of the corner portion of the carrier board 31, which is caused by processing error, is within the tolerance allowed in the designed outline of the object to be detected. The positional deviation can be obtained by calculating the offsets between the two internal-external distances of D-D and D-D-b, and between the two internal-external distances of D-H and D-H-b.

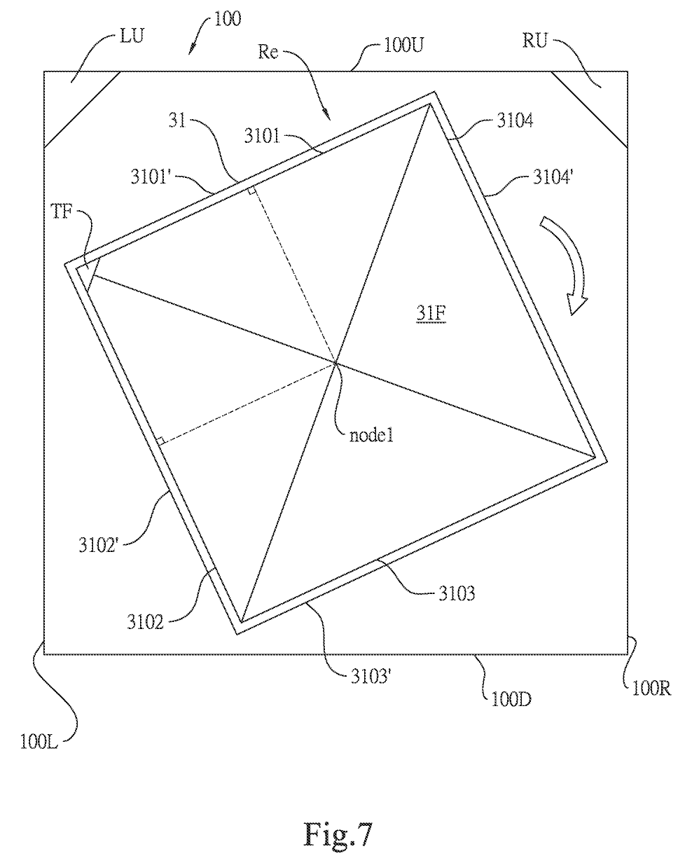

FIG. 7 is a schematic diagram showing a state in which the virtual outline of the polygonal object to be detected is about to be aligned with the designed outline of the polygonal object according to the present invention. In order to clearly show how the obtained polygonal result Re of the virtual outline is to be aligned with the designed outline according to the present invention, FIG. 7 presents the top side 31F of the obtained polygonal result Re having a relatively exaggerated rotation angle with respect to the designed outline. A skilled person in the art should know that such an exaggerated positional deviation will not actually occur. Based on the description for the images captured as FIGS. 5A to 5D and 6A to 6B, the first internal edge line 3101, the second internal edge line 3102, the third internal edge line 3103 and the fourth internal edge line 3104 as well as the first external edge line 3101’, the second external edge line 3102’, the third external edge line 3103’ and the fourth eternal edge line 3104’ and their locations are all clearly identified, and all of the numerals of the required distances are calculated. A comparing platform 100 having an image processing unit is provided for detecting the offset between the virtual outline and the designed outline of the object. The virtual field of view of the image processing unit of the comparing platform 100 can match the effective field of view of each camera device (such as a camera device having a CCD or CMOS sensor), for example. As shown in FIG. 7, The virtual field of view of the comparing platform 100 includes an upper edge 100U, a lower edge 100D, a left edge 100L and a right edge 100R. If the carrier board 31 to be detected has the top triangle mark TF disposed thereon, and the field of view of the screen has a top alignment mark LU disposed therein, then the orientation that aligns with the top alignment mark LU is set as the predetermined orientation. Please refer to FIG. 7, wherein the intersection point node1 as the reference point for comparing the virtual outline with the designed outline of the object has been determined, as previously described for FIG. 1. It can be seen that the polygonal result Re of the virtual outline is counter-clockwisely deviated from the field of view of screen of the comparing platform 100. By clockwisely rotating the polygonal result Re of the virtual outline based on the intersection point node 1 as a center of rotation until the top triangle mark TF in the virtual outline is right in the same orientation of the top alignment mark LU, which means that the polygonal result Re of the virtual outline having the top triangle mark TF is uprightly in alignment with the field of view of the screen of the comparing platform 100 having the top alignment mark LU. At this moment, the preliminary alignement operation prior to comparing the designed outline is completed. Similarly, the opposite intersection point node2 as the reference point for comparing the virtual outline with the designed outline of the object has been determined, as previously described for FIG. 2. The back side 31B of the virtual outline can be rotated based on the opposite intersection point node 2 as a center of rotation until the back triangle mark TB in the virtual outline is right in the same orientation of the back alignment mark RU, which means that the polygonal result Re of the virtual outline having the back triangle mark TB is uprightly in alignment with the field of view of the screen of the comparing platform 100 having the back alignment mark RU. The obtained data are treated by the comparing platform 100 with a software for image analysis and comparison. For ease of explanation, the comparing platform 100 is visualized and presented as a platform in the present invention, and thus can be considered as a planar coordinate system. The orientation and posture of the comparison platform 100 are exactly the same as those of the design outline, so as to align the polygonal result Re of the virtual outline with the designed outline for comparison. For example, after the alignment, the horizontal direction of the virtual outline obtained by the plural camera devices shown in FIG. 4 are parallel to the upper edge 100U and the lower edge 100D of the comparison platform 100; and the vertical direction of the virtual outline obtained by the plural camera devices shown in FIG. 4 are parallel to the left edge 100L and the right edge 100R of the comparison platform 100.

Please further refer to FIG. 7. If none of the top triangle mark TF and the back triangle mark TB is present on the carrier board 31, one of the first internal edge 3101, the second internal edge 3102, the third internal edge 3103 and the fourth internal edge 3104 can be selected as a marking line (or a base line), and one of the upper edge 100U, the lower edge 100D, the left edge 100L and the right edge 100R of the comparison platform 100 can be set as a reference line to be aligned with the internal edge selected as the marking line. For example, by taking the intersection point node1 as the center of rotation, the first internal edge 3101 as the marking line, and the upper edge 100U as the reference line, the polygonal result Re is rotated based on the intersection point node1 until the first internal edge 3101 is adjacent and parallel to the upper edge 100U. Similarly, the back side polygonal result of the back side 31B shown in FIG. 2 (i.e., the polygonal result that is captured and calculated from the obtained data of the entire back side 31B shown in FIG. 2 ) can also be rotated around the opposite intersection point node2 as the center of rotation until the selected marking line is adjacent and parallel to the selected reference line.

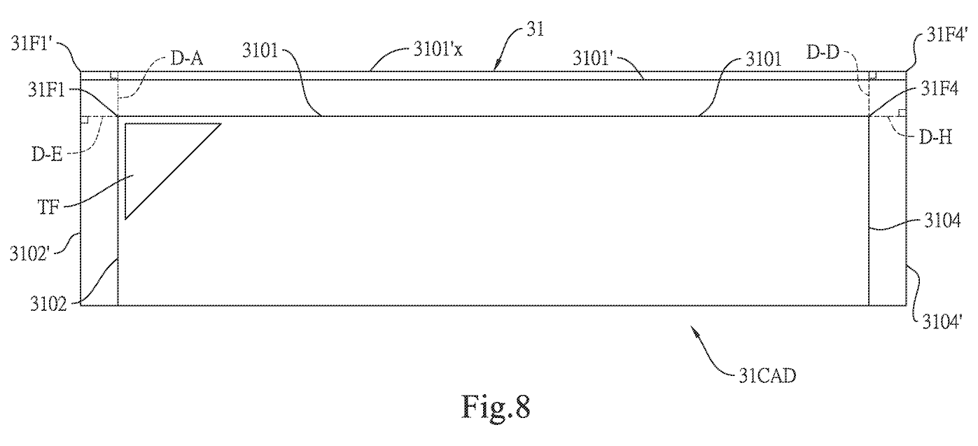

FIG. 8 is a schematic diagram showing a comparison result between the virtual outline and the designed outline of the polygonal object according to the present invention. Please refer to FIG. 8, as an example, which is viewed from a direction facing the first internal edge line 3101 of the top surface 31F of the carrier board 31, wherein the numerals on the designed outline 31CAD of the carrier board are numbered the same as those shown in the previous figures and will not be repeatedly described again. The measured first external edge 3101'x represents the polygonal result obtained by calculation after the carrier board 31 is captured by the camera device. If the internal-external distance D-A at position A (i.e. the distance from the measured first external edge line 3101'x to the first internal edge 3101 adjacent to the first internal corner 31F1) is 315 units, the internal-external distance D-D at position D is 303 units (the distance from the measured first external edge line 3101'x to the first internal edge line 3101 adjacent to the fourth internal corner 31F4), and the measured first external edge line 3101'x is compared with the first external edge line 3101' of outline of the carrier board drawing 31CAD, the actual offset between the measured first external edge line 3101'x and the first external edge 3101' of the designed outline 31CAD of the carrier board can be obtained, and the carrier board 31 can be determined to be well processed, to be reprocessed/modified, or to be discarded based on the predetermined tolerance value. The above only takes the internal-external distance between the first internal edge line 3101 and the measured first external edge line 3101'x as an example, and the other examples similar thereto can be realized.

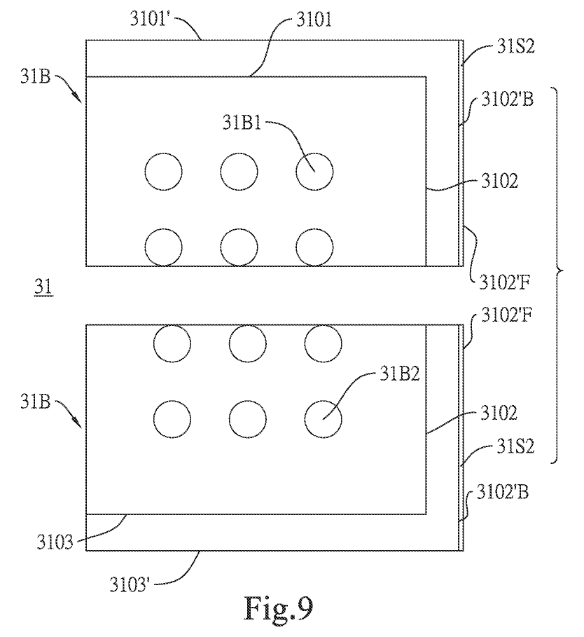

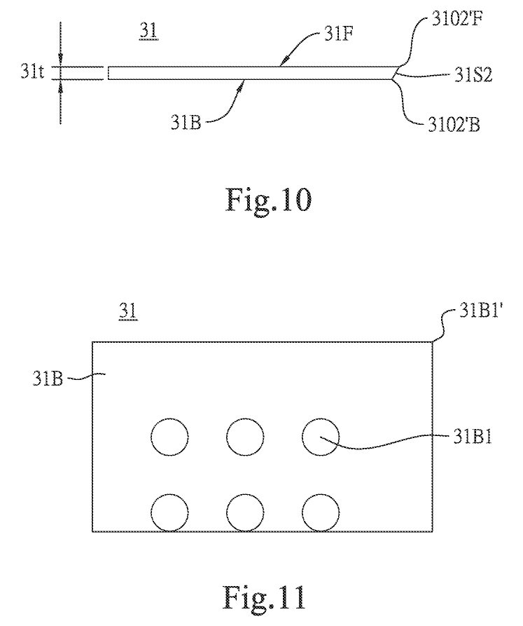

FIG. 9 is a schematic diagram showing a comparison result between the top side and the back side of the virtual outline of the polygonal object according to another embodiment of the present invention. FIG. 10 is a schematic diagram showing a front view of FIG. 9. The reference numerals in FIG. 9 follows those in the previous figures, and thus will not be described in detail. Please refer to FIG. 9 together with FIG. 10. FIG. 9 shows the polygonal result combining the aligned top side 31F of the carrier board 31 (as shown in FIG. 1) and the aligned back side 31B of the carrier board 31 (as shown in FIG. 2). The intersection point node1 (as shown in FIG. 1) is overlapped with the opposite intersection point node2 (as shown in FIG. 2), and then the corresponding external edge lines of the top side 31F and the back side 31B are compared. Before comparison, the polygonal results shown in FIGS. 5A to 5D are turned left to right, so that the orientation of each of the second internal and external edge lines 3102, 3102' shown in FIGS. 5A and 5B are consistent with that of each of the second internal and external edge lines 3102, 3102' shown in FIGS. 6A and 6B. FIG. 10 shows the second external edge line 3102'B and the top second external edge line 3102'F viewed from a direction parallel to the top side 31F and the back side 31B of the carrier board 31. It can also be said that FIG. 10 is a side view of FIG. 9. FIG. 9 shows a diagram viewed from the direction facing the back side 31B of the carrier board 31, so it can also be said that FIG. 9 is a rear view of the carrier board 31. After comparison, the second external edge line 3102'B on the back side 31B, and the second external edge line 3102'F on the top side 31F are obtained. It can be seen that the second external edge line 3102'F is more protruding, or based on the different view of point, the second external edge line 3102'B on the back is more retracted. Further refer to FIG. 10, wherein it can be seen that the second lateral edge 31S2 of the carrier board 31 at this point is inclined. Therefore, it can be seen from FIGS. 9 and 10 that the second lateral edge 31S2 of the carrier board 31 has some deviation during processing, which means that the second lateral edge 31S2 has a slope, and is not perpendicular to any of the top side 31F and the back side 31B of the carrier board 31. The “processing” here refers to cutting the carrier board 31 from the mother board, and/or trimming the burrs present on the lateral edge of the carrier board 31 after cutting. Furthermore, please refer again to FIG. 10, the thickness 31t shown in the designed outline of the carrier board 31 is introduced into the second lateral edge 31S2 to obtain the inclination or slope of the second lateral edge 31S2 and determine whether the inclination or slope exceeds the tolerance value to determine whether reprocessing, modification, or discarding the carrier board 31 is required.

In more detail, the polygonal object has a first surface including the first circuit area having plural internal corners, and the plural feature points are determined by the following steps: capturing plural internal corner images for the plural internal corners; and determining plural feature points from the plural internal corner images. The polygonal object further has a second surface opposite to the first surface and having a second outline mirrored to the first outline and including a second circuit area opposite to the first circuit area, the second circuit area has plural opposite internal corners opposite to the plural internal corners and has a plurality of solder joints, and the method further comprises the following steps: capturing plural solder joint images for four solder joints included in the plurality of solder joints and respectively closest to the plural opposite internal corners; determining four opposite feature points from the plural solder joint images; forming an opposite virtual outline by connecting the four opposite feature points in one of a clockwise direction and a counterclockwise direction; forming a third virtual line connecting two opposite feature points non-adjacent to each other along the opposite virtual outline; forming a fourth virtual line connecting another two opposite feature points; determining an opposite intersection point based on the third virtual line and the fourth virtual line; taking the opposite intersection point as an opposite center of rotation; rotating the opposite virtual outline along the opposite center of rotation to generate an opposite orientation-aligned outline; and comparing the orientation-aligned outline with the opposite orientation-aligned outline to obtain a top-to-back offset.

The plurality of the feature points for the first surface are four feature points, each of the four feature points and the four opposite feature points are captured by a camera device for comparing the orientation-aligned outline with the opposite orientation-aligned outline, the polygonal object has a thickness, and the method further comprises the step of calculating a slope of a side having the thickness of the polygonal object based on the top-to-back offset.

FIG. 11 is a schematic diagram showing one corner portion of the top side of the virtual outline of the polygonal object, and the solder joints on the back side at the same corner portion. By comparing the top side 31F and the back side 31B of the carrier board 31 shown in FIG. 9 and FIG. 10, the relative position of the first internal corner 31F1 on the top side and the first corner solder joint 31B1 can be measured to determine whether the relative position, or the distance, to the internal corner compared with the one in the designed outline meets the designed value.

It can be seen from the accompanying drawings and the descriptions that the present invention provides great assistance to smoothly inspecting the size, shape and contour of the carrier board by setting a center or rotation so that the polygonal result of the virtual outline is rotated around the center of rotation to match the designed outline of the carrier board to be detected. After rotating the virtual outline to an orientation that aligns with the designed outline, the obtained image can be compared with the design outline to obtain the deviations on the size of the produced carrier board. In addition, the center of rotation does not necessarily have to be based on the intersection of the two lines connecting the respective feature points. The center of gravity, center of mass, and centroid obtained from the polygonal results can also be used as the center of rotation, which increases the flexibility of the present invention because the method of the present invention can also be used for inspecting an irregular-edge shaped (e.g., arc-shaped) object to be detected. It can be seen that the user no longer needs to fix the carrier board on the tray precisely, but only needs to make sure that the carrier board is fixed on the tray and will not fall out of the tray as usual, which greatly saves operation time and makes a significant contribution to the calibration and comparison of the products such as carrier boards and circuit boards having a polygonal planar structure.

Embodiment 1: The present invention provides a method for detecting an offset between an outline of a polygonal object produced and a designed outline under a design for the polygonal object, wherein the polygonal object having thereon a non-effective area and a circuit area surrounded by the non-effective area, the circuit area having plural internal corners and plural solder joints. The method comprises the following steps: capturing an outline image for the outline of the polygonal object to obtain a virtual outline; capturing ones of (1) plural internal corner images for the plural internal corners, and (2) plural solder joint images for plural solder joints closest to the plural internal corners; determining plural feature points based on ones of (1) the plural internal corner images and (2) the plural solder joint images; forming a first virtual line connecting two feature points non-adjacent to each other on the virtual outline; forming a second virtual line connecting another two feature points; determining an intersection point based on the first virtual line and the second virtual line; taking the intersection point as a center of rotation; rotating the virtual outline along the center of rotation to a specific orientation, in which the virtual outline is supposed to be aligned with the designed outline, to generate an orientation-aligned outline; and comparing the orientation-aligned outline with the designed outline to obtain the offset.

Embodiment 2: The present invention provides the method according to Embodiment 1, wherein the polygonal object includes a pair of alignment marks disposed thereon, and the step of rotating the virtual outline of the polygonal object to the specific orientation is based on a detection of two mark positions of the pair of alignment marks.

Embodiment 3: The present invention provides the method according to Embodiment 1 or 2, wherein after the step of rotating the virtual outline to the specific orientation, the method further comprises the following step: selecting a side of the polygonal object to match with a corresponding side in the design for comparing the orientation-aligned outline with the designed outline.

Embodiment 4: The present invention provides the method according to any of Embodiments 1-3, wherein each step of capturing the outline image and capturing the internal corner image is performed by a camera device for sensing the outline image to be compared with the designed outline, and a base side for defining the specific orientation is parallel to one side of the designed outline.

Embodiment 5. The present invention provides a method for detecting an offset of an outline of a polygonal object produced from a designed outline therefor. The method comprises the following steps: determining at least four feature points from the outline of the polygonal object; obtaining a virtual polygonal outline by connecting the at least four feature points in one of a clockwise direction and a counterclockwise direction; forming a first virtual line connecting two of the plural feature points non-adjacent to each other on the virtual polygonal outline; forming a second virtual line connecting another two of the feature points; taking an intersection point of the first virtual line and the second virtual line as a center of rotation; rotating the virtual outline along the center of rotation to a specific orientation to generate an orientation-aligned outline corresponding to the designed outline; and comparing the orientation-aligned outline with the designed outline to obtain the offset.

Embodiment 6: The present invention provides the method according to Embodiment 5, wherein the at least four feature points are plural feature points, and the first virtual line and the second virtual line are two respective virtual diagonal lines of the virtual outline.

Embodiment 7: The present invention provides the method according to Embodiment 5 or 6, wherein the polygonal object includes a pair of alignment marks disposed thereon, and the step of rotating the virtual outline of the polygonal object is based on detecting positions of the pair of alignment marks.

Embodiment 8: The present invention provides the method according to any of Embodiments 5-7, wherein after the step of rotating the virtual outline, the method further comprises the following step: selecting a side of the polygonal object to match with a corresponding side in the design for comparing the orientation-aligned outline with the designed outline.

Embodiment 9: The present invention provides the method according to any of Embodiments 5-8, wherein each of the at least four feature points is captured by a camera device for comparing the orientation-aligned outline with the designed outline, and a base side defining the specific orientation of the orientation-aligned outline is parallel to one side of the designed outline.

Embodiment 10: The present invention provides a method of adjusting an orientation of an image of a polygonal object obtained by detecting a first outline of the polygonal object. The method comprises the following steps: (a) determining a plurality of feature points from the outline of the polygonal object; (b) identifying a plurality of positional parameters for the plurality of feature points; (c) obtaining a virtual outline of the polygonal object by associating the plurality of positional parameters; (d) determining a center of rotation based on the virtual outline; and (e) rotating the virtual outline along the center of rotation to the orientation to generate an orientation-aligned outline.

Embodiment 11: The present invention provides the method according to Embodiment 10, wherein the method further comprises the following step: comparing the orientation-aligned outline with a designed outline to obtain an offset.

Embodiment 12: The present invention provides the method according to Embodiment 10 or 11, wherein the offset includes at least one of a displacement offset and an angular offset.

Embodiment 13: The present invention provides the method according to any of Embodiments 10-12, wherein the step (d) of determining the center of rotation based on the virtual outline comprises the following steps: (d1) forming a first virtual line connecting two feature points of the plurality of feature points non-adjacent to each other along the virtual outline; (d2) forming a second virtual line connecting another two feature points of the plurality of feature points; and (d3) determining an intersection of the first virtual line and the second virtual line to be the center of rotation.

Embodiment 14: The present invention provides the method according to any of Embodiments 10-13, wherein the plurality of the feature points are four feature points, and the first virtual line and the second virtual line are two respective virtual diagonal lines of the virtual outline.

Embodiment 15: The present invention provides the method according to any of Embodiments 10-14, wherein the polygonal object has a first surface including a first circuit area having plural internal corners, and the plural feature points are determined by the following steps: capturing plural internal corner images for the plural internal corners; and determining plural feature points from the plural internal corner images.

Embodiment 16: The present invention provides the method according to any of Embodiments 10-15, wherein the polygonal object further has an opposite second surface having a second outline mirrored to the first outline and including a second circuit area opposite to the first circuit area, the second circuit area has plural second opposite internal corners opposite to the first plural internal corners and has a plurality of solder joints, and the method further comprises the following steps: capturing plural solder joint images for four solder joints included in the plurality of solder joints and respectively closest to the plural opposite internal corners; determining four opposite feature points from the plural solder joint images; forming a virtual opposite outline by connecting the four opposite feature points in one of a clockwise direction and a counterclockwise direction; forming a third virtual line connecting two opposite feature points non-adjacent to each other along the virtual opposite outline; forming a fourth virtual line connecting another two opposite feature points; determining an opposite intersection point based on the third virtual line and the fourth virtual line; taking the opposite intersection point as an opposite center of rotation; rotating the virtual opposite outline along the opposite center of rotation to generate an orientation-aligned opposite outline; and comparing the first orientation-aligned outline with the orientation-aligned opposite outline to obtain a top-to-back offset.

Embodiment 17: The present invention provides the method according to any of Embodiments 10-16, wherein the outline image, the internal corner images, and the plural solder joint images are captured by a camera device having an image processing unit for comparing the outline image with a designed outline, the polygonal object has a thickness, and the method further comprises the following steps: introducing the thickness as a parameter to the image processing unit; and calculating a slope of a side having the thickness of the polygonal object based on the top-to-back offset.

Embodiment 18: The present invention provides the method according to Embodiments 10-17, wherein the outline image and the internal corner images are captured by a camera device having an image processing unit for comparing the outline image with the designed outline, and a base side for defining the orientation is parallel to one side of the designed outline compared by the image sensing unit.

Embodiment 19: The present invention provides the method according to any of Embodiments 10-18, wherein the center of rotation is determined as one of a center of weight, a center of mass and a center of shape based on the virtual outline of the polygonal object.

Embodiment 20: The present invention provides the method according to any of Embodiments 10-19, wherein the polygonal object includes a pair of alignment marks disposed thereon, and the step of rotating the virtual outline of the polygonal object is based on detecting positions of the pair of alignment marks.

In addition, based on the descriptions for FIGS. 1 and 2, the present invention provides a method for detecting an offset of an outline of a polygonal object produced from a designed outline therefor. The method comprises the following steps: determining at least four feature points from the outline of the polygonal object; obtaining a virtual polygonal outline by connecting the at least four feature points in one of a clockwise direction and a counterclockwise direction; forming a first virtual line connecting two of the plural feature points non-adjacent to each other on the virtual polygonal outline; forming a second virtual line connecting another two of the feature points; taking an intersection point of the first virtual line and the second virtual line as a center of rotation; rotating the virtual outline along the center of rotation to a specific orientation to generate an orientation-aligned outline corresponding to the designed outline; and comparing the orientation-aligned outline with the designed outline to obtain the offset.

In addition, based on the descriptions for FIGS. 1 and 2, the present invention provides a method for adjusting an orientation of an image of a polygonal object obtained by detecting a first outline of the polygonal object. The method comprises the following steps: (a) determining a plurality of feature points from the outline of the polygonal object; (b) identifying a plurality of positional parameters for the plurality of feature points; (c) obtaining a virtual outline of the polygonal object by associating the plurality of positional parameters; (d) determining a center of rotation based on the virtual outline; and (e) rotating the virtual outline along the center of rotation to the orientation to generate a first orientation-aligned outline.

While the invention has been described in terms of what is presently considered to be the most practical and preferred embodiments, it is to be understood that the invention need not be limited to the disclosed embodiments. On the contrary, it is intended to cover various modifications and similar arrangements included within the spirit and scope of the appended claims which are to be accorded with the broadest interpretation so as to encompass all such modifications and similar structures.

1. A method for detecting an offset between an outline of a polygonal object produced and a designed outline under a design for the polygonal object, the polygonal object having thereon a non-effective area and a circuit area surrounded by the non-effective area, the circuit area having plural internal corners and plural solder joints, the method comprising the following steps:
capturing an outline image for the outline of the polygonal object to obtain a virtual outline;
capturing ones of (1) plural internal corner images for the plural internal corners, and (2) plural solder joint images for plural solder joints closest to the plural internal corners;
determining plural feature points based on ones of (1) the plural internal corner images and (2) the plural solder joint images;
forming a first virtual line connecting two feature points non-adjacent to each other on the virtual outline;
forming a second virtual line connecting another two feature points;
determining an intersection point based on the first virtual line and the second virtual line;
taking the intersection point as a center of rotation;
rotating the virtual outline along the center of rotation to a specific orientation, in which the virtual outline is supposed to be aligned with the designed outline, to generate an orientation-aligned outline; and
comparing the orientation-aligned outline with the designed outline to obtain the offset.

2. The method according to claim 1, wherein the polygonal object includes a pair of alignment marks disposed thereon, and the step of rotating the virtual outline of the polygonal object to the specific orientation is based on a detection of two mark positions of the pair of alignment marks.

3. The method according to claim 1, after the step of rotating the virtual outline to the specific orientation, further comprising the following step:
selecting a side of the polygonal object to match with a corresponding side in the design for comparing the orientation-aligned outline with the designed outline.

4. The method according to claim 1, wherein each step of capturing the outline image and capturing the internal corner image is performed by a camera device for sensing the outline image to be compared with the designed outline, and a base side for defining the specific orientation is parallel to one side of the designed outline.

5. A method for detecting an offset of an outline of a polygonal object produced from a designed outline therefor, comprising the following steps:
determining at least four feature points from the outline of the polygonal object;
obtaining a virtual polygonal outline by connecting the at least four feature points in one of a clockwise direction and a counterclockwise direction;
forming a first virtual line connecting two of the plural feature points non-adjacent to each other on the virtual polygonal outline;
forming a second virtual line connecting another two of the feature points;
taking an intersection point of the first virtual line and the second virtual line as a center of rotation;
rotating the virtual outline along the center of rotation to a specific orientation to generate an orientation-aligned outline corresponding to the designed outline; and
comparing the orientation-aligned outline with the designed outline to obtain the offset.

6. The method according to claim 5, wherein the at least four feature points are plural feature points, and the first virtual line and the second virtual line are two respective virtual diagonal lines of the virtual outline.

7. The method according to claim 5, wherein the polygonal object includes a pair of alignment marks disposed thereon, and the step of rotating the virtual outline of the polygonal object is based on detecting positions of the pair of alignment marks.

8. The method according to claim 5, after the step of rotating the virtual outline, further comprising the following step:
selecting a side of the polygonal object to match with a corresponding side in the design for comparing the orientation-aligned outline with the designed outline.

9. The method according to claim 5, wherein each of the at least four feature points is captured by a camera device for comparing the orientation-aligned outline with the designed outline, and a base side defining the specific orientation of the orientation-aligned outline is parallel to one side of the designed outline.

10. A method of adjusting an orientation of an image of a polygonal object obtained by detecting a first outline of the polygonal object, comprising the following steps:
(a) determining a plurality of feature points from the outline of the polygonal object;
(b) identifying a plurality of positional parameters for the plurality of feature points;
(c) obtaining a virtual outline of the polygonal object by associating the plurality of positional parameters;
(d) determining a center of rotation based on the virtual outline; and
(e) rotating the virtual outline along the center of rotation to the orientation to generate an orientation-aligned outline.

11. The method according to claim 10, further comprising the following step:
comparing the orientation-aligned outline with a designed outline to obtain an offset.

12. The method according to claim 11, wherein the offset includes at least one of a displacement offset and an angular offset.

13. The method according to claim 10, wherein the step (d) of determining the center of rotation based on the virtual outline comprises the following steps:
(d1) forming a first virtual line connecting two feature points of the plurality of feature points non-adjacent to each other along the virtual outline;
(d2) forming a second virtual line connecting another two feature points of the plurality of feature points; and
(d3) determining an intersection of the first virtual line and the second virtual line to be the center of rotation.

14. The method according to claim 13, wherein the plurality of the feature points are four feature points, and the first virtual line and the second virtual line are two respective virtual diagonal lines of the virtual outline.

15. The method according to claim 13, wherein the polygonal object has a first surface including a first circuit area having plural internal corners, and the plural feature points are determined by the following steps:
capturing plural internal corner images for the plural internal corners; and
determining plural feature points from the plural internal corner images.

16. The method according to claim 15, wherein the polygonal object further has a second surface opposite to the first surface and having a second outline mirrored to the first outline and including a second circuit area opposite to the first circuit area, the second circuit area has plural opposite internal corners opposite to the plural internal corners and has a plurality of solder joints, and the method further comprises the following steps:
capturing plural solder joint images for four solder joints included in the plurality of solder joints and respectively closest to the plural opposite internal corners;
determining four opposite feature points from the plural solder joint images;
forming an opposite virtual outline by connecting the four opposite feature points in one of a clockwise direction and a counterclockwise direction;
forming a third virtual line connecting two opposite feature points non-adjacent to each other along the opposite virtual outline;
forming a fourth virtual line connecting another two opposite feature points;
determining an opposite intersection point based on the third virtual line and the fourth virtual line;
taking the opposite intersection point as an opposite center of rotation;
rotating the opposite virtual outline along the opposite center of rotation to generate an opposite orientation-aligned outline; and
comparing the orientation-aligned outline with the opposite orientation-aligned outline to obtain a top-to-back offset.

17. The method according to claim 16, wherein the plurality of the feature points are four feature points , the four feature points and the four opposite feature points are captured by a camera device for comparing the orientation-aligned outline with the opposite orientation-aligned outline, the polygonal object has a thickness, and the method further comprises the following step:
calculating a slope of a side having the thickness of the polygonal object based on the top-to-back offset.

18. The method according to claim 13, wherein the outline image and the internal corner images are captured by a camera device for comparing the orientation-aligned outline with the designed outline, and a base side for defining the orientation is parallel to one side of the designed outline.

19. The method according to claim 10, wherein the center of rotation is determined as one of a center of weight, a center of mass and a center of shape based on the virtual outline of the polygonal object.

20. The method according to claim 10, wherein the polygonal object includes a pair of alignment marks disposed thereon, and the step of rotating the virtual outline of the polygonal object is based on detecting positions of the pair of alignment marks.
